(19) United States
(12) Patent Application Publication
(10) Pub. No.: US 2013/0053478 A1
(43) Pub. Date: Feb. 28, 2013

(54) STARCH-POLYMER-OIL COMPOSITIONS, METHODS OF MAKING AND USING THE SAME

(71) Applicants: Eric Bryan Bond, Maineville, OH (US); William Maxwell Allen, Liberty Township, OH (US); Donald Stuart Murray, Liberty Township, OH (US); Isao Noda, Fairfield, OH (US)

(72) Inventors: Eric Bryan Bond, Maineville, OH (US); William Maxwell Allen, Liberty Township, OH (US); Donald Stuart Murray, Liberty Township, OH (US); Isao Noda, Fairfield, OH (US)

(21) Appl. No.: 13/474,632

(22) Filed: May 17, 2012

Related U.S. Application Data
(60) Provisional application No. 61/488,522, filed on May 20, 2011.

(51) Int. Cl. C08L 3/00; C08K 5/053; C08L 23/12

(52) U.S. Cl. 524/52

(57) ABSTRACT

Compositions comprising thermoplastic starch, thermoplastic polymers, and oils, waxes, or combinations thereof are disclosed, where the oil, wax, or combination is dispersed throughout the thermoplastic polymer. Also disclosed are methods of making these compositions.

### CROSS REFERENCE TO RELATED APPLICATION

This application claims the benefit of U.S. Provisional Application No. 61/488,522 filed May 20, 2012.

### FIELD OF THE INVENTION

The present invention relates to compositions comprising intimate admixtures of thermoplastic starch, thermoplastic polymers and oils, waxes, or combinations thereof. The present invention also relates to methods of making these compositions.

### BACKGROUND OF THE INVENTION

Thermoplastic polymers are used in a wide variety of applications. However, thermoplastic polymers, such as polypropylene and polyethylene, pose additional challenges compared to other polymer species, especially with respect to formation of, for example, fibers. This is because the material and processing requirements for production of fibers are much more stringent than for producing other forms, for example, films. For the production of fibers, polymer melt flow characteristics are more demanding on the material's physical and rheological properties vs other polymer processing methods. Also, the local shear/extensional rate and shear rate are much greater in fiber production than other processes and, for spinning very fine fibers, small defects, slight inconsistencies, or phase incompatibilities in the melt are not acceptable for a commercially viable process. Moreover, high molecular weight thermoplastic polymers cannot be easily or effectively spun into fine fibers. Given their availability and potential strength improvement, it would be desirable to provide a way to easily and effectively spin such high molecular weight polymers.

Most thermoplastic polymers, such as polyethylene, polypropylene, and polyethylene terephthalate, are derived from monomers (e.g., ethylene, propylene, and terephthalic acid, respectively) that are obtained from non-renewable, fossil-based resources (e.g., petroleum, natural gas, and coal). Thus, the price and availability of these resources ultimately have a significant impact on the price of these polymers. As the worldwide price of these resources escalates, so does the price of materials made from these polymers. Furthermore, many consumers display an aversion to purchasing products that are derived solely from petrochemicals. In some instances, consumers are hesitant to purchase products made from non-renewable fossil-based resources, which are non-renewable fossil based resources. Other consumers may have adverse perceptions about products derived from petrochemicals as being “unnatural” or not environmentally friendly.

Thermoplastic polymers and thermoplastic starches are often incompatible with, or have poor miscibility with additives (e.g., oils, pigments, organic dyes, perfumes, etc.) that might otherwise contribute to a reduced consumption of these polymers in the manufacture of downstream articles. Heretofore, the art has not effectively addressed how to reduce the amount of thermoplastic polymers derived from non-renewable, fossil-based resources in the manufacture of common articles employing these polymers. Accordingly, it would be desirable to address this deficiency. Existing art has combined polypropylene with additives, with polypropylene as the minor component to form cellular structures. These cellular structures are the purpose behind including renewable materials that are later removed or extracted after the structure is formed. U.S. Pat. No. 3,093,612 describes the combination of polypropylene with various fatty acids where the fatty acid is removed. The scientific paper J. Apply. Polym. Sci 82 (1) pp. 169-177 (2001) discloses use of diluents on polypropylene for thermally induced phase separation to produce an open and large cellular structure but at low polymer ratio, where the diluent is subsequently removed from the final structure. The scientific paper J. Apply. Polym. Sci 105 (4) pp. 2000-2007 (2007) produces microporous membranes via thermally induced phase separation with dibutyl phthalate and soy bean oil mixtures, with a minor component of polypropylene. The diluent is removed in the final structure. The scientific paper Journal of Membrane Science 108 (1-2) pp. 25-36 (1995) produces hollow fiber microporous membranes using soy bean oil and polypropylene mixtures, with a minor component of polypropylene and using thermally induced phase separation to produce the desired membrane structure. The diluent is removed in the final structure. In all of these cases, the diluent as described is removed to produce the final structure. These structures before the diluent is removed are oily with excessive amounts of diluent to produce very open microporous structures with pore sizes >10 μm.

Thus, a need exists for compositions of thermoplastic starch and thermoplastic polymers that allow for use of higher molecular weight and/or decreased non-renewable resource based materials, and/or incorporation of further additives, such as perfumes and dyes. A still further need is for compositions that leave the additive present to deliver renewable materials in the final product and that can also enable the addition of further additives into the final structure, such as dyes and perfumes, for example.

### SUMMARY OF THE INVENTION

In one aspect, the invention is directed to compositions comprising an intimate admixture of a thermoplastic starch (TPS), a thermoplastic polymer and an oil, wax, or combination thereof present in an amount of about 5 wt % to about 40 wt %, based upon the total weight of the composition. The composition can be in the form of pellets produced to be used as-is or for storage for future use, for example to make fibers. Optionally, the composition can be further processed into the final usable form, such as fibers, films and molded articles.

The thermoplastic polymer can comprise a polyolefin, a polyester, a polyamide, copolymers thereof, or combinations thereof. The thermoplastic polymer can comprise polypropylene, and can have a melt flow index of greater than 5 g/10 min or of greater than 10 g/10 min. The thermoplastic polymer can be selected from the group consisting of polypropylene, polyethylene, polypropylene co-polymer, polyethylene co-polymer, polyethylene terephthalate, polybutylene terepthalate, polylactic acid, polyhydroxyalkanoates, polyamide-6, polyamide-6,6, and combinations thereof. The preferred thermoplastic polymer comprises polypropylene. The polypropylene can have a weight average molecular weight of about 20 kDa to about 400 kDa. The thermoplastic polymer can be present in the composition in an amount of about 20 wt % to about 90 wt %, about 30 wt % to about 70 wt %, based upon the total weight of the composition. The thermoplastic polymer can be derived from a renewable bio-based feed stock origin, such as bio polyethylene or bio polypropylene, and/or can be recycled source, such as post consumer use.

The oil, wax, or combination thereof can be present in the composition in an amount of about 5 wt % to about 40 wt %, about 8 wt % to about 30 wt %, or about 10 wt % to about 20 wt %, based upon the total weight of the composition. The oil, wax, or combination thereof can comprise a lipid, which can be selected from the group consisting of a monoglyceride, diglyceride, triglyceride, fatty acid, fatty alcohol, esterified fatty acid, epoxidized lipid, maleated lipid, hydrogenated lipid, alkyd resin derived from a lipid, sucrose polyester, or combinations thereof. The wax can be selected from the group consisting of a hydrogenated plant oil, a partially hydrogenated plant oil, an epoxidized plant oil, a maleated plant oil. Specific examples of such plant oils include soy bean oil, corn oil, canola oil, and palm kernel oil. The oil, wax, or combination thereof can comprise a mineral oil or wax, such as a linear alkane, a branched alkane, or combinations thereof. The oil, wax, or combination thereof can be selected from the group consisting of soy bean oil, epoxidized soy bean oil, maleated soy bean oil, corn oil, cottonseed oil, canola oil, beef tallow, castor oil, coconut oil, coconut seed oil, corn germ oil, fish oil, linseed oil, olive oil, oiticica oil, palm kernel oil, palm oil, palm seed oil, peanut oil, rapeseed oil, safflower oil, sperm oil, sunflower seed oil, tall oil, tung oil, whale oil, tristearin, triolein, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, trilinolein, 1,2-dipalmitolinolein, 1-palmito-dilinolein, 1-stearo-dilinolein, 1,2-diacetopalmitin, 1,2-distearo-olein, 1,3-distearo-olein, trimyristin, trilaurin, capric acid, caproic acid, caprylic acid, lauric acid, lauroleic acid, linoleic acid, linolenic acid, myristic acid, myristoleic acid, oleic acid, palmitic acid, palmitoleic acid, stearic acid, and combinations thereof.

The oil, wax, or combination thereof can be dispersed within the thermoplastic starch and thermoplastic polymer such that the oil, wax, or combination has a droplet size of less than 10 μm, less than 5 μm, less than 1 μm, or less than 500 nm within the thermoplastic polymer. The oil, wax, or combination can be a renewable material.

The thermoplastic starch (TPS) can comprise a starch or a starch derivative and a plasticizer. The thermoplastic starch can be present in an amount about 10 wt % to about 80 wt % or about 20 wt % to about 40 wt %, based upon the total weight of the composition.

The plasticizer can comprise a polyol. Specific polyols contemplated include mannitol, sorbitol, glycerin, and combinations thereof. The plasticizer can be selected from the group consisting of glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2,6-hexanetriol, 1,3,5-hexanetriol, neopentyl glycol, trimethylolpropane, pentaerythritol, sorbitol, glycerol ethoxylate, tridecyl adipate, isodecyl benzoate, tributyl citrate, tributyl phosphate, dimethyl sebacate, urea, pentaerythritol ethoxylate, sorbitol acetate, pentaerythritol acetate, ethylenebisformamide, sorbitol diacetate, sorbitol monoethoxylate, sorbitol diethoxylate, sorbitol hexaethoxylate, sorbitol dipropoxylate, aminosorbitol, trihydroxymethylaminomethane, glucose/PEG, a reaction product of ethylene oxide with glucose, trimethylolpropane monoethoxylate, mannitol monoacetate, mannitol monoethoxylate, butyl glucoside, glucose monoethoxylate, α-methyl glucoside, carboxymethylsorbitol sodium salt, sodium lactate, polyglycerol monoethoxylate, erythriol, arabitol, adonitol, xylitol, mannitol, iditol, galactitol, allitol, malitol, formaide, N-methylformamide, dimethyl sulfoxide, an alkylamide, a polyglycerol having 2 to 10 repeating units, and combinations thereof.

The starch or starch derivative can be selected from the group consisting of starch, hydroxyethyl starch, hydroxypropyl starch, carboxymethylated starch, starch phosphate, starch acetate, a cationic starch, (2-hydroxy-3-trimethyl(ammoniumpropyl) starch chloride, a starch modified by acid, base, or enzyme hydrolysis, a starch modified by oxidation, and combinations thereof.

The compositions disclosed herein can further comprise an additive. The additive can be oil soluble or oil dispersible. Examples of additives include perfume, dye, pigment, surfactant, nanoparticle, nucleating agent, clarifying agent, anti-microbial agent, antistatic agent, filler, or combination thereof.

In another aspect, provided is a method of making a composition as disclosed herein, the method comprising a) mixing the thermoplastic polymer, in a molten state, with the wax, also in the molten state, to form the admixture; and b) cooling the admixture to a temperature at or less than the solidification temperature of the thermoplastic polymer in 10 seconds or less to form the composition. The method of making a composition can comprise a) melting a thermoplastic polymer to form a molten thermoplastic polymer; b) mixing the molten thermoplastic polymer and a wax to form an admixture; and c) cooling the admixture to a temperature at or less than the solidification temperature of the thermoplastic polymer in 10 seconds or less. The mixing can be at a shear rate of greater than 10 s⁻¹, or about 30 to about 100 s⁻¹. The admixture can be cooled in 10 seconds or less to a temperature of 50° C. or less. The composition can be pelletized. The pelletizing can occur after cooling the admixture or before or simultaneous to cooling the admixture. The composition can be made using an extruder, such as a single- or twin-screw extruder. Alternatively, the method of making a composition can comprise a) melting a thermoplastic polymer to form a molten thermoplastic polymer; b) mixing the molten thermoplastic polymer and a wax to form an admixture; and c) extruding the molten mixture to form the finished structure, for example filaments or fibers which solidify upon cooling.

### DETAILED DESCRIPTION OF THE INVENTION

Compositions disclosed herein comprise an intimate admixture of a thermoplastic starch, thermoplastic polymer, and an oil, wax or combination thereof. The term “intimate admixture” refers to the physical relationship of the oil or wax, the thermoplastic starch, and thermoplastic polymer, wherein the oil or wax is dispersed within the thermoplastic polymer and/or thermoplastic starch. The droplet size of the oil or wax within in the thermoplastic polymer is a parameter that indicates the level of dispersion of the oil or wax within the thermoplastic polymer and/or thermoplastic starch. The smaller the droplet size, the higher the dispersion of the oil or wax within the thermoplastic polymer and/or thermoplastic starch, the larger the droplet size the lower the dispersion of the oil or wax within the thermoplastic polymer and/or thermoplastic starch. The oil, wax, or both associate with the thermoplastic polymer, but are mixed into both the TPS and thermoplastic polymer during formation of the compositions as disclosed herein. As used herein, the term “admixture” refers to the intimate admixture of the present invention, and not an “admixture” in the more general sense of a standard mixture of materials.

The droplet size of the oil or wax within the thermoplastic polymer and/or thermoplastic starch is less than 10 μm, and can be less than 5 μm, less than 1 μm, or less than 500 nm. Other contemplated droplet sizes of the oil and/or wax dispersed within the thermoplastic polymer and/or thermoplastic starch include less than 9.5 μm, less than 9 μm, less than 8.5 μm, less than 8 μm, less than 7.5 μm, less than 7 μm, less than 6.5 μm, less than 6 μm, less than 5.5 μm, less than 4.5 μm, less than 4 μm, less than 3.5 μm, less than 3 μm, less than 2.5 μm, less than 2 μm, less than 1.5 μm, less than 900 nm, less than 800 nm, less than 700 nm, less than 600 nm, less than 400 nm, less than 300 nm, and less than 200 nm.

The droplet size of the oil or wax can be measured by scanning electron microscopy (SEM) indirectly by measuring a void size in the thermoplastic polymer and/or thermoplastic starch, after removal of the oil and/or wax from the composition. Removal of the oil or wax is typically performed prior to SEM imaging due to incompatibility of the oil or wax and the SEM imaging technique. Thus, the void measured by SEM imaging is correlated to the droplet size of the oil or wax in the composition.

One exemplary way to achieve the dispersion of the oil or wax within the thermoplastic polymer and/or thermoplastic starch is by admixing the thermoplastic polymer, in a molten state, the thermoplastic starch, in the molten state, and the oil and/or wax (which is also in the molten state). Each of the thermoplastic polymer and thermoplastic starch is melted (e.g., exposed to temperatures greater than the solidification temperature) to provide the molten thermoplastic polymer and molten thermoplastic starch, and mixed with the oil or wax. One or both of the thermoplastic polymer and thermoplastic starch can be melted prior to addition of the oil or wax or one or both can be melted in the presence of the oil or wax.

The thermoplastic polymer, thermoplastic starch, and oil or wax can be mixed, for example, at a shear rate of greater than 10 s⁻¹. Other contemplated shear rates include greater than 10, about 15 to about 1000, or up to 500 s⁻¹. The higher the shear rate of the mixing, the greater the dispersion of the oil or wax in the composition as disclosed herein. Thus, the dispersion can be controlled by selecting a particular shear rate during formation of the composition.

The oil or wax and molten thermoplastic polymer and molten thermoplastic starch can be mixed using any mechanical means capable of providing the necessary shear rate to result in a composition as disclosed herein. Non-limiting examples of mechanical means include a mixer, such as a Haake batch mixer, and an extruder (e.g., a single- or twin-screw extruder).

The mixture of molten thermoplastic polymer, molten thermoplastic starch, and oil or wax is then rapidly (e.g., in less than 10 seconds) cooled to a temperature lower than the solidification temperature (either via traditional thermoplastic polymer crystallization or passing below the polymer glass transition temperature) of the thermoplastic polymer and/or thermoplastic starch. The admixture can be cooled to less than 200° C., less than 150° C., less than 100° C. less than 75° C., less than 50° C., less than 40° C., less than 30° C., less than 20° C., less than 15° C., less than 10° C., or to a temperature of about 0° C. to about 30° C., about 0° C. to about 20° C., or about 0° C. to about 10° C. For example, the mixture can be placed in a low temperature liquid (e.g., the liquid is at or below the temperature to which the mixture is cooled) or gas. The liquid can be ambient or controlled temperature water. The gas can be ambient air or controlled temperature and humidity air. Any quenching media can be used so long as it cools the admixture rapidly. Additional liquids such as oils, alcohols and ketones can be used for quenching, along with mixtures comprising water (sodium chloride for example) depending on the admixture composition. Additional gases can be used, such as carbon dioxide and nitrogen, or any other component naturally occurring in atmospheric temperature and pressure air.

Optionally, the composition is in the form of pellets. Pellets of the composition can be formed prior to, simultaneous to, or after cooling of the mixture. The pellets can be formed by strand cutting or underwater pelletizing. In strand cutting, the composition is rapidly quenched (generally in a time period much less than 10 seconds) then cut into small pieces. In underwater pelletizing, the mixture is cut into small pieces and simultaneously or immediately thereafter placed in the presence of a low temperature liquid that rapidly cools and solidifies the mixture to form the pelletized composition. Such pelletizing methods are well understood by the ordinarily skilled artisan. Pellet morphologies can be round or cylindrical, and preferably have no dimension larger than 10 mm, more preferably less than 5 mm, or no dimension larger than 2 mm.

Alternatively, the admixture (admixture and mixture or used interchangeably here within this document) can be used whilst mixed in the molten state and formed directly into fibers, for example. Other suitable forms are films and molded articles.

### Thermoplastic Starch

As used herein, “thermoplastic starch” or “TPS” means a native starch or a starch derivative that has been rendered thermoplastic by treatment with one or more plasticizers. Thermoplastic starch compositions are well known and disclosed in several patents, for example: U.S. Pat. Nos. 5,280,055; 5,314,934; 5,362,777; 5,844,023; 6,214,907; 6,242,102; 6,096,809; 6,218,321; 6,235,815; 6,235,816; and 6,231,970, each incorporated herein by reference.

Starch:

The starch used in the disclosed compositions is destructurized starch. The term “thermoplastic starch” refers to destructured starch with a plasticizer.

Since natural starch generally has a granular structure, it needs to be destructurized before it can be melt processed like a thermoplastic material. For gelatinization, e.g., the process of destructuring the starch, the starch can be destructurized in the presence of a solvent which acts as a plasticizer. The solvent and starch mixture is heated, typically under pressurized conditions and shear to accelerate the gelatinization process. Chemical or enzymatic agents may also be used to destructurize, oxidize, or derivatize the starch. Commonly, starch is destructured by dissolving the starch in water. Fully destructured starch results when the particle size of any remaining undestructured starch does not impact the extrusion process, e.g., the fiber spinning process. Any remaining undestructured starch particle sizes are less than 30 μm, preferably less 20 μm, more preferably less than 10 μm, or less than 5 μm. The residual particle size can be determined by pressing the final formulation into a thin film (50 μm or less) and placing the film into a light microscope under cross polarized light. Under cross polarized light, the signature maltese cross, indicative of undestructured starch, can be observed. If the average size of these particle is above the target range, the destructured starch has not been prepared properly.

Suitable naturally occurring starches can include, but are not limited to, corn starch, potato starch, sweet potato starch, wheat starch, sago palm starch, tapioca starch, rice starch, soybean starch, arrow root starch, bracken starch, lotus starch, cassaya starch, waxy maize starch, high amylose corn starch, and commercial amylose powder. Blends of starch may also be used. Though all starches are useful herein, the present invention is most commonly practiced with natural starches derived from agricultural sources, which offer the advantages of being abundant in supply, easily replenishable and inexpensive in price. Naturally occurring starches, particularly corn starch, wheat starch, and waxy maize starch, are the preferred starch polymers of choice due to their economy and availability.

Modified starch may also be used. Modified starch is defined as non-substituted or substituted starch that has had its native molecular weight characteristics changed (i.e. the molecular weight is changed but no other changes are necessarily made to the starch). If modified starch is desired, chemical modifications of starch typically include acid or alkali hydrolysis and oxidative chain scission to reduce molecular weight and molecular weight distribution. Natural, unmodified starch generally has a very high average molecular weight and a broad molecular weight distribution (e.g. natural corn starch has an average molecular weight of up to about 60,000,000 grams/mole (g/mol)). The average molecular weight of starch can be reduced to the desirable range for the present invention by acid reduction, oxidation reduction, enzymatic reduction, hydrolysis (acid or alkaline catalyzed), physical/mechanical degradation (e.g., via the thermomechanical energy input of the processing equipment), or combinations thereof. The thermomechanical method and the oxidation method offer an additional advantage when carried out in situ. The exact chemical nature of the starch and molecular weight reduction method is not critical as long as the average molecular weight is in an acceptable range.

Ranges of number average molecular weight for starch or starch blends added to the melt can be from about 3,000 g/mol to about 20,000,000 g/mol, preferably from about 10,000 g/mol to about 10,000,000 g/mol, preferably from about 15,000 to about 5,000,000 g/mol, more preferably from about 20,000 g/mol to about 3,000,000 g/mol. In other embodiments, the average molecular weight is otherwise within the above ranges but about 1,000,000 or less, or about 700,000 or less.

Substituted starch can be used. If substituted starch is desired, chemical modifications of starch typically include etherification and esterification. Substituted starches may be desired for better compatibility or miscibility with the thermoplastic polymer and plasticizer. Alternatively, modified and substituted starches can be used to aid in the destructuring process by increasing the gelatinization process. However, this must be balanced with the reduction in the rate of degradability. The degree of substitution of the chemically substituted starch is from about 0.01 to 3.0. A low degree of substitution, 0.01 to 0.06, may be preferred.

The weight of starch in the composition includes starch and its naturally occurring bound water content. The term “bound water” means the water found naturally occurring in starch and before mixing of starch with other components to make the composition of the present invention. The term “free water” means the water that is added in making the composition of the present invention. A person of ordinary skill in the art would recognize that once the components are mixed in a composition, water can no longer be distinguished by its origin. The starch typically has a bound water content of about 5% to 16% by weight of starch. It is known that additional free water may be incorporated as the polar solvent or plasticizer, and not included in the weight of the starch.

Plasticizer:

A plasticizer can be used in the present invention to destructurize the starch and enable the starch to flow, i.e. create a thermoplastic starch. The same plasticizer may be used to increase melt processability or two separate plasticizers may be used. The plasticizers may also improve the flexibility of the final products, which is believed to be due to the lowering of the glass transition temperature of the composition by the plasticizer. The plasticizers should preferably be substantially compatible with the polymeric components of the disclosed compositions so that the plasticizers may effectively modify the properties of the composition. As used herein, the term “substantially compatible” means when heated to a temperature above the softening and/or the melting temperature of the composition, the plasticizer is capable of forming a substantially homogeneous mixture with starch.

An additional plasticizer or diluent for the thermoplastic polymer may be present to lower the polymer's melting temperature and improve overall compatibility with the thermoplastic starch blend. Furthermore, thermoplastic polymers with higher melting temperatures may be used if plasticizers or diluents are present which suppress the melting temperature of the polymer. The plasticizer will typically have a molecular weight of less than about 100,000 g/mol and may preferably be a block or random copolymer or terpolymer where one or more of the chemical species is compatible with another plasticizer, starch, polymer, or combinations thereof.

Nonlimiting examples of useful hydroxyl plasticizers include sugars such as glucose, sucrose, fructose, raffinose, maltodextrose, galactose, xylose, maltose, lactose, mannose erythrose, glycerol, and pentaerythritol; sugar alcohols such as erythritol, xylitol, malitol, mannitol and sorbitol; polyols such as ethylene glycol, propylene glycol, dipropylene glycol, butylene glycol, hexane triol, and the like, and polymers thereof; and mixtures thereof. Also useful herein as hydroxyl plasticizers are poloxomers and poloxamines. Also suitable for use herein are hydrogen bond forming organic compounds which do not have hydroxyl group, including urea and urea derivatives; anhydrides of sugar alcohols such as sorbitan; animal proteins such as gelatin; vegetable proteins such as sunflower protein, soybean proteins, cotton seed proteins; and mixtures thereof. Other suitable plasticizers are phthalate esters, dimethyl and diethylsuccinate and related esters, glycerol triacetate, glycerol mono and diacetates, glycerol mono, di, and tripropionates, and butanoates, which are biodegradable. Aliphatic acids such as ethylene acrylic acid, ethylene maleic acid, butadiene acrylic acid, butadiene maleic acid, propylene acrylic acid, propylene maleic acid, and other hydrocarbon based acids. All of the plasticizers may be use alone or in mixtures thereof.

Preferred plasticizers include glycerin, mannitol, and sorbitol, with sorbitol being the most preferred. The amount of plasticizer is dependent upon the molecular weight, amount of starch, and the affinity of the plasticizer for the starch. Generally, the amount of plasticizer increases with increasing molecular weight of starch.

The thermoplastic starch can be present in the compositions disclosed herein in a weight percent of about 10 wt % to about 80 wt %, about 10 wt % to about 60 wt %, or about 20 wt % to about 40 wt %, based upon the total weight of the composition. Specific contemplated amounts of thermoplastic starch include about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, and about 80 wt %, based upon the total weight of the composition.

### Thermoplastic Polymers

Thermoplastic polymers, as used in the disclosed compositions, are polymers that melt and then, upon cooling, crystallize or harden, but can be re-melted upon further heating. Suitable thermoplastic polymers used herein have a melting temperature (also referred to as solidification temperature) from about 60° C. to about 300° C., from about 80° C. to about 250° C., or from 100° C. to 215° C., with the preferred range from 100° C. to 180° C.

The molecular weight of the thermoplastic polymer is sufficiently high to enable entanglement between polymer molecules and yet low enough to be melt spinnable. Addition of the oil into the composition allows for compositions containing higher molecular weight thermoplastic polymers to be processed, compared to compositions without an oil. Thus, suitable thermoplastic polymers can have weight average molecular weights of about 1000 kDa or less, about 5 kDa to about 800 kDa, about 10 kDa to about 700 kDa, or about 20 kDa to about 400 kDa.

The thermoplastic polymers can be derived from renewable resources or from fossil minerals and oils. The thermoplastic polymers derived from renewable resources are bio-based, for example such as bio produced ethylene and propylene monomers used in the production polypropylene and polyethylene. These material properties are essentially identical to fossil based product equivalents, except for the presence of carbon-14 in the thermoplastic polymer. Renewable and fossil based thermoplastic polymers can be combined together in the present invention in any ratio, depending on cost and availability. Recycled thermoplastic polymers can also be used, alone or in combination with renewable and/or fossil derived thermoplastic polymers. The recycled thermoplastic polymers can be pre-conditioned to remove any unwanted contaminants prior to compounding or they can be used during the compounding and extrusion process, as well as simply left in the admixture. These contaminants can include trace amounts of other polymers, pulp, pigments, inorganic compounds, organic compounds and other additives typically found in processed polymeric compositions. The contaminants should not negatively impact the final performance properties of the admixture, for example, causing spinning breaks during a fiber spinning process.

Suitable thermoplastic polymers generally include polyolefins, polyesters, polyamides, copolymers thereof, and combinations thereof. The thermoplastic polymer can be selected from the group consisting of polypropylene, polyethylene, polypropylene co-polymer, polyethylene co-polymer, polyethylene terepthalate, polybutylene terepthalate, polylactic acid, polyhydroxyalkanoates, polyamide-6, polyamide-6,6, and combinations thereof. The polymer can be polypropylene based, polyethylene based, polyhydroxyalkanoate based polymer systems, copolymers and combinations thereof.

More specifically, however, the thermoplastic polymers preferably include polyolefins such as polyethylene or copolymers thereof, including low, high, linear low, or ultra low density polyethylenes, polypropylene or copolymers thereof, including atactic polypropylene; isotactic polypropylene, metallocene isotactic polypropylene, polybutylene or copolymers thereof; polyamides or copolymers thereof, such as Nylon 6, Nylon 11, Nylon 12, Nylon 46, Nylon 66; polyesters or copolymers thereof, such as maleic anhydride polypropylene copolymer, polyethylene terephthalate; olefin carboxylic acid copolymers such as ethylene/acrylic acid copolymer, ethylene/maleic acid copolymer, ethylene/methacrylic acid copolymer, ethylene/vinyl acetate copolymers or combinations thereof; polyacrylates, polymethacrylates, and their copolymers such as poly(methyl methacrylates). Other nonlimiting examples of polymers include polycarbonates, polyvinyl acetates, poly(oxymethylene), styrene copolymers, polyacrylates, polymethacrylates, poly(methyl methacrylates), polystyrene/methyl methacrylate copolymers, polyetherimides, polysulfones, or combinations thereof. In some embodiments, thermoplastic polymers include polypropylene, polyethylene, polyamides, polyvinyl alcohol, ethylene acrylic acid, polyolefin carboxylic acid copolymers, polyesters, and combinations thereof.

More specifically, however, the thermoplastic polymers preferably include polyolefins such as polyethylene or copolymers thereof, including low density, high density, linear low density, or ultra low density polyethylenes such that the polyethylene density ranges between 0.90 grams per cubic centimeter to 0.97 grams per cubic centimeter, most preferred between 0.92 and 0.95 grams per cubic centimeter. The density of the polyethylene will is determined by the amount and type of branching and depends on the polymerization technology and comonomer type. Polypropylene and/or polypropylene copolymers, including atactic polypropylene; isotactic polypropylene, syndiotactic polypropylene, and combination thereof can also be used. Polypropylene copolymers, especially ethylene can be used to lower the melting temperature and improve properties. These polypropylene polymers can be produced using metallocene and Ziegler-Natta catalyst systems. These polypropylene and polyethylene compositions can be combined together to optimize end-use properties. Polybutylene is also a useful polyolefin.

Biodegradable thermoplastic polymers also are contemplated for use herein. Biodegradable materials are susceptible to being assimilated by microorganisms, such as molds, fungi, and bacteria when the biodegradable material is buried in the ground or otherwise contacts the microorganisms (including contact under environmental conditions conducive to the growth of the microorganisms). Suitable biodegradable polymers also include those biodegradable materials which are environmentally-degradable using aerobic or anaerobic digestion procedures, or by virtue of being exposed to environmental elements such as sunlight, rain, moisture, wind, temperature, and the like. The biodegradable thermoplastic polymers can be used individually or as a combination of biodegradable or non-biodegradable polymers. Biodegradable polymers include polyesters containing aliphatic components. Among the polyesters are ester polycondensates containing aliphatic constituents and poly(hydroxycarboxylic) acid. The ester polycondensates include diacids/diol aliphatic polyesters such as polybutylene succinate, polybutylene succinate co-adipate, aliphatic/aromatic polyesters such as terpolymers made of butylene diol, adipic acid and terephthalic acid. The poly(hydroxycarboxylic) acids include lactic acid based homopolymers and copolymers, polyhydroxybutyrate (PHB), or other polyhydroxyalkanoate homopolymers and copolymers. Such polyhydroxyalkanoates include copolymers of PHB with higher chain length monomers, such as C₆-C₁₂, and higher, polyhydroxyalkanaotes, such as those disclosed in U.S. Pat. Nos. RE 36,548 and 5,990,271.

An example of a suitable commercially available polylactic acid is NATUREWORKS from Cargill Dow and LACEA from Mitsui Chemical. An example of a suitable commercially available diacid/diol aliphatic polyester is the polybutylene succinate/adipate copolymers sold as BIONOLLE 1000 and BIONOLLE 3000 from the Showa High Polymer Company, Ltd. (Tokyo, Japan). An example of a suitable commercially available aliphatic/aromatic copolyester is the poly(tetramethylene adipate-co-terephthalate) sold as EASTAR BIO Copolyester from Eastman Chemical or ECOFLEX from BASF.

Non-limiting examples of suitable commercially available polypropylene or polypropylene copolymers include Basell Profax PH-835 (a 35 melt flow rate Ziegler-Natta isotactic polypropylene from Lyondell-Basell), Basell Metocene MF-650W (a 500 melt flow rate metallocene isotactic polypropylene from Lyondell-Basell), Polybond 3200 (a 250 melt flow rate maleic anhydride polypropylene copolymer from Crompton), Exxon Achieve 3854 (a 25 melt flow rate metallocene isotactic polypropylene from Exxon-Mobil Chemical), Mosten NB425 (a 25 melt flow rate Ziegler-Natta isotactic polypropylene from Unipetrol), Danimer 27510 (a polyhydroxyalkanoate polypropylene from Danimer Scientific LLC), Dow Aspun 6811A (a 27 melt index polyethylene polypropylene copolymer from Dow Chemical), and Eastman 9921 (a polyester terephthalic homopolymer with a nominally 0.81 intrinsic viscosity from Eastman Chemical).

The thermoplastic polymer component can be a single polymer species as described above or a blend of two or more thermoplastic polymers as described above.

If the polymer is polypropylene, the thermoplastic polymer can have a melt flow index of greater than 0.5 g/10 min, as measured by ASTM D-1238, used for measuring polypropylene. Other contemplated melt flow indices include greater than 5 g/10 min, greater than 10 g/10 min, or about 5 g/10 min to about 50 g/10 min

### Oils and Waxes

An oil or wax, as used in the disclosed composition, is a lipid, mineral oil (or wax), or combination thereof. An oil is used to refer to a compound that is liquid at room temperature (e.g., has a melting point of 25° C. or less) while a wax is used to refer to a compound that is a solid at room temperature (e.g., has a melting point of greater than 25° C.). The wax can also have a melting point lower than the melting temperature of the highest volumetric polymer component in the composition. The term wax hereafter can refer to the component either in the solid crystalline state or in the molten state, depending on the temperature. The wax can be solid at a temperature at which the thermoplastic polymer and/or thermoplastic starch are solid. For example, polypropylene is a semicrystalline solid at 90° C., which can be above melting temperature of the wax.

A wax, as used in the disclosed composition, is a lipid, mineral wax, or combination thereof, wherein the lipid, mineral wax, or combination thereof has a melting point of greater than 25° C. More preferred is a melting point above 35° C., still more preferred above 45° C. and most preferred above 50° C. The wax can have a melting point that is lower than the melting temperature of the thermoplastic polymer in the composition. The terms “wax” and “oil” are deferentiated by crystallinity of the component at or near 25° C. In all cases, the “wax” will have a maximum melting temperature less than the thermoplastic polymer, preferably less than 100° C. and most preferably less than 80° C. The wax can be a lipid. The lipid can be a monoglyceride, diglyceride, triglyceride, fatty acid, fatty alcohol, esterified fatty acid, epoxidized lipid, maleated lipid, hydrogenated lipid, alkyd resin derived from a lipid, sucrose polyester, or combinations thereof. The mineral wax can be a linear alkane, a branched alkane, or combinations thereof. The waxes can be partially or fully hydrogenated materials, or combinations and mixtures thereof, that were formally liquids at room temperature in their unmodified forms. When the temperature is above the melting temperature of the wax, it is a liquid oil. When in the molten state, the wax can be referred to as an “oil”. The terms “wax” and “oil” only have meaning when measured at 25° C. The wax will be a solid at 25° C., while an oil is not a solid at 25° C. Otherwise they are used interchangeably above 25° C.

The lipid can be a monoglyceride, diglyceride, triglyceride, fatty acid, fatty alcohol, esterified fatty acid, epoxidized lipid, maleated lipid, hydrogenated lipid, alkyd resin derived from a lipid, sucrose polyester, or combinations thereof. The mineral oil or wax can be a linear alkane, a branched alkane, or combinations thereof. The waxes can be partially or fully hydrogenated materials, or combinations and mixtures thereof, that were formally liquids at room temperature in their unmodified forms.

Non-limiting examples of oils or waxes contemplated in the compositions disclosed herein include beef tallow, castor oil, coconut oil, coconut seed oil, corn germ oil, cottonseed oil, fish oil, linseed oil, olive oil, oiticica oil, palm kernel oil, palm oil, palm seed oil, peanut oil, rapeseed oil, safflower oil, soybean oil, sperm oil, sunflower seed oil, tall oil, tung oil, whale oil, and combinations thereof. Non-limiting examples of specific triglycerides include triglycerides such as, for example, tristearin, triolein, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, trilinolein, 1,2-dipalmitolinolein, 1-palmito-dilinolein, 1-stearo-dilinolein, 1,2-diacetopalmitin, 1,2-distearo-olein, 1,3-distearo-olein, trimyristin, trilaurin and combinations thereof. Non-limiting examples of specific fatty acids contemplated include capric acid, caproic acid, caprylic acid, lauric acid, lauroleic acid, linoleic acid, linolenic acid, myristic acid, myristoleic acid, oleic acid, palmitic acid, palmitoleic acid, stearic acid, and mixtures thereof. Because the wax may contain a distribution of melting temperatures to generate a peak melting temperature, the wax melting temperature is defined as having a peak melting temperature 25° C. or above as defined as when >50 weight percent of the wax component melts at or above 25° C. This measurement can be made using a differential scanning calorimeter (DSC), where the heat of fusion is equated to the weight percent fraction of the wax.

The wax number average molecular weight, as determined by gel permeation chromatography (GPC), should be less than 2 kDa, preferably less than 1.5 kDa, still more preferred less than 1.2 kDa.

The amount of wax is determined via gravimetric weight loss method. The solidified mixture is placed, with the narrowest specimen dimension no greater than 1 mm, into acetone at a ratio of 1 g or mixture per 100 g of acetone using a refluxing flask system. First the mixture is weighed before being placed into the reflux flask, and then the acetone and mixtures are heated to 60° C. for 20 hours. The sample is removed and air dried for 60 minutes and a final weight determined. The equation for calculating the weight percent wax is

weight % wax=([initial mass−final mass]/[initial mass])×100%

Because the oil may contain a distribution of melting temperatures to generate a peak melting temperature, the oil melting temperature is defined as having a peak melting temperature 25° C. or below as defined when >50 weight percent of the oil component melts at or below 25° C. This measurement can be made using a differential scanning calorimeter (DSC), where the heat of fusion is equated to the weight percent fraction of the oil.

The oil number average molecular weight, as determined by gel permeation chromatography (GPC), should be less than 2 kDa, preferably less than 1.5 kDa, still more preferred less than 1.2 kDa.

The amount of oil is determined via gravimetric weight loss method. The solidified mixture is placed, with the narrowest specimen dimension no greater than 1 mm, into hexane (or acetone) at a ratio of 1 g or mixture per 100 g of hexane using a refluxing flask system. First the mixture is weighed before being placed into the reflux flask, and then the hexane and mixtures are heated to 60° C. for 20 hours. The sample is removed and air dried for 60 minutes and a final weight determined. The equation for calculating the weight percent oil is

weight % oil=([initial mass−final mass]/[initial mass])×100%

The oil or wax can be from a renewable material (e.g., derived from a renewable resource). As used herein, a “renewable resource” is one that is produced by a natural process at a rate comparable to its rate of consumption (e.g., within a 100 year time frame). The resource can be replenished naturally, or via agricultural techniques. Non-limiting examples of renewable resources include plants (e.g., sugar cane, beets, corn, potatoes, citrus fruit, woody plants, lignocellulosics, hemicellulosics, cellulosic waste), animals, fish, bacteria, fungi, and forestry products. These resources can be naturally occurring, hybrids, or genetically engineered organisms. Natural resources such as crude oil, coal, natural gas, and peat, which take longer than 100 years to form, are not considered renewable resources. Mineral oil, petroleum, and petroleum jelly are viewed as a by-product waste stream of coal, and while not renewable, it can be considered a by-product oil.

Specific examples of mineral wax include paraffin (including petrolatum), Montan wax, as well as polyolefin waxes produced from cracking processes, preferentially polyethylene derived waxes. Mineral waxes and plant derived waxes can be combined together. Plant based waxes can be differentiated by their carbon-14 content.

The oil or wax, as disclosed herein, is present in the composition at a weight percent of about 5 wt % to about 40 wt %, based upon the total weight of the composition. Other contemplated wt % ranges of the oil or wax include about 8 wt % to about 30 wt %, with a preferred range from about 10 wt % to about 30 wt %, about 10 wt % to about 20 wt %, or about 12 wt % to about 18 wt %, based upon the total weight of the composition. Specific oil or wax wt % contemplated include about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, and about 40 wt %, based upon the total weight of the composition.

### Additives

The compositions disclosed herein can further include an additive. The additive can be dispersed throughout the composition, or can be substantially in the thermoplastic polymer portion of the thermoplastic layer, substantially in the oil portion of the composition, or substantially in the TPS portion of the composition. In cases where the additive is in the oil portion of the composition, the additive can be oil soluble or oil dispersible. Alkyd resins can also be added to the composition. Alkyd resins comprise, for example, polyols, polyacids, and/or anhydrides.

Non-limiting examples of classes of additives contemplated in the compositions disclosed herein include perfumes, dyes, pigments, nanoparticles, antistatic agents, fillers, and combinations thereof. The compositions disclosed herein can contain a single additive or a mixture of additives. For example, both a perfume and a colorant (e.g., pigment and/or dye) can be present in the composition. The additive(s), when present, is/are present in a weight percent of about 0.05 wt % to about 20 wt %, or about 0.1 wt % to about 10 wt %. Specifically contemplated weight percentages include about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, about 8 wt %, about 8.1 wt %, about 8.2 wt %, about 8.3 wt %, about 8.4 wt %, about 8.5 wt %, about 8.6 wt %, about 8.7 wt %, about 8.8 wt %, about 8.9 wt %, about 9 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, and about 10 wt %.

As used herein the term “perfume” is used to indicate any odoriferous material that is subsequently released from the composition as disclosed herein. A wide variety of chemicals are known for perfume uses, including materials such as aldehydes, ketones, alcohols, and esters. More commonly, naturally occurring plant and animal oils and exudates including complex mixtures of various chemical components are known for use as perfumes. The perfumes herein can be relatively simple in their compositions or can include highly sophisticated complex mixtures of natural and synthetic chemical components, all chosen to provide any desired odor. Typical perfumes can include, for example, woody/earthy bases containing exotic materials, such as sandalwood, civet and patchouli oil. The perfumes can be of a light floral fragrance (e.g. rose extract, violet extract, and lilac). The perfumes can also be formulated to provide desirable fruity odors, e.g. lime, lemon, and orange. The perfumes delivered in the compositions and articles of the present invention can be selected for an aromatherapy effect, such as providing a relaxing or invigorating mood. As such, any material that exudes a pleasant or otherwise desirable odor can be used as a perfume active in the compositions and articles of the present invention.

A pigment or dye can be inorganic, organic, or a combination thereof. Specific examples of pigments and dyes contemplated include pigment Yellow (C.I. 14), pigment Red (C.I. 48:3), pigment Blue (C.I. 15:4), pigment Black (C.I. 7), and combinations thereof. Specific contemplated dyes include water soluble ink colorants like direct dyes, acid dyes, base dyes, and various solvent soluble dyes. Examples include, but are not limited to, FD&C Blue 1 (C.I. 42090:2), D&C Red 6(C.I. 15850), D&C Red 7(C.I. 15850:1), D&C Red 9(C.I. 15585:1), D&C Red 21(C.I. 45380:2), D&C Red 22(C.I. 45380:3), D&C Red 27(C.I. 45410:1), D&C Red 28(C.I. 45410:2), D&C Red 30(C.I. 73360), D&C Red 33(C.I. 17200), D&C Red 34(C.I. 15880:1), and FD&C Yellow 5(C.I. 19140:1), FD&C Yellow 6(C.I. 15985:1), FD&C Yellow 10(C.I. 47005:1), D&C Orange 5(C.I. 45370:2), and combinations thereof.

Contemplated fillers include, but are not limited to inorganic fillers such as, for example, the oxides of magnesium, aluminum, silicon, and titanium. These materials can be added as inexpensive fillers or processing aides. Other inorganic materials that can function as fillers include hydrous magnesium silicate, titanium dioxide, calcium carbonate, clay, chalk, boron nitride, limestone, diatomaceous earth, mica glass quartz, and ceramics. Additionally, inorganic salts, including alkali metal salts, alkaline earth metal salts, phosphate salts, can be used.

Contemplated surfactants include anionic surfactants, amphoteric surfactants, or a combination of anionic and amphoteric surfactants, and combinations thereof, such as surfactants disclosed, for example, in U.S. Pat. Nos. 3,929,678 and 4,259,217 and in EP 414 549, WO93/08876 and WO93/08874.

Contemplated nanoparticles include metals, metal oxides, allotropes of carbon, clays, organically modified clays, sulfates, nitrides, hydroxides, oxy/hydroxides, particulate water-insoluble polymers, silicates, phosphates and carbonates. Examples include silicon dioxide, carbon black, graphite, grapheme, fullerenes, expanded graphite, carbon nanotubes, talc, calcium carbonate, betonite, montmorillonite, kaolin, silica, aluminosilicates, boron nitride, aluminum nitride, barium sulfate, calcium sulfate, antimony oxide, feldspar, mica, nickel, copper, iron, cobalt, steel, gold, silver, platinum, aluminum, wollastonite, aluminum oxide, zirconium oxide, titanium dioxide, cerium oxide, zinc oxide, magnesium oxide, tin oxide, iron oxides (Fe₂O₃, Fe₃O₄) and mixtures thereof. Nanoparticles can increase strength, thermal stability, and/or abrasion resistance of the compositions disclosed herein, and can give the compositions electric properties.

Additional contemplated additives include nucleating and clarifying agents for the thermoplastic polymer. Specific examples, suitable for polypropylene, for example, are benzoic acid and derivatives (e.g. sodium benzoate and lithium benzoate), as well as kaolin, talc and zinc glycerolate. Dibenzlidene sorbitol (DBS) is an example of a clarifying agent that can be used. Other nucleating agents that can be used are organocarboxylic acid salts, sodium phosphate and metal salts (for example aluminum dibenzoate) The nucleating or clarifying agents can be added in ranges from 20 parts per million (20 ppm) to 20,000 ppm, more preferred range of 200 ppm to 2000 ppm and the most preferred range from 1000 ppm to 1500 ppm. The addition of the nucleating agent can be used to improve the tensile and impact properties of the finished admixture composition.

Contemplated anti-static agents include fabric softeners which are known to provide antistatic benefits. For example those fabric softeners that have a fatty acyl group which has an iodine value of above 20, such as N,N-di(tallowoyl-oxy-ethyl)-N,N-dimethyl ammonium methylsulfate.

### Processes of Making the Compositions as Disclosed Herein

Melt Mixing of the Polymer, Starch, and Oil:

The polymer, TPS, and oil and/or wax can be suitably mixed by melting the polymer and TPS in the presence of the oil and/or wax. It should be understood that when the thermoplastic polymer and TPS are melted, the wax will also be in the molten state. In the melt state, the polymer, TPS, and oil and/or wax are subjected to shear which enables a dispersion of the oil into the polymer and/or TPS. In the melt state, the oil and/or wax and polymer and/or TPS are significantly more compatible with each other.

The melt mixing of the thermoplastic polymer, TPS, and oil and/or wax can be accomplished in a number of different processes, but processes with high shear are preferred to generate the preferred morphology of the composition. The processes can involve traditional thermoplastic polymer processing equipment. The general process order involves adding the thermoplastic polymer and TPS to the system, melting the thermoplastic polymer and TPS, and then adding the oil and/or wax. However, the materials can be added in any order, depending on the nature of the specific mixing system.

For the disclosed processes, the thermoplastic starch (TPS) is prepared prior to mixing with a thermoplastic polymer and/or an oil and/or wax. U.S. Pat. Nos. 7,851,391, 6,783,854 and 6,818,295 describe processes for producing TPS. However, TPS can be made in-line and the thermoplastic polymer and oil/wax combined in the same production process to make the compositions as disclosed herein in a single step process. For example, the starch, starch plasticizer and thermoplastic polymer are combined first in a twin-screw extruder where TPS is formed in the presence of the thermoplastic polymer. Later, the oil/wax is introduced into the TPS/thermoplastic polymer mixture via a second feeding location.

Single Screw Extruder:

A single screw extruder is a typical process unit used in most molten polymer extrusion. The single screw extruder typically includes a single shaft within a barrel, the shaft and barrel engineered with certain screw elements (e.g., shapes and clearances) to adjust the shearing profile. A typical RPM range for single screw extruder is about 10 to about 120. The single screw extruder design is composed of a feed section, compression section and metering section. In the feed section, using fairly high void volume flights, the polymer is heated and supplied into the compression section, where the melting is completed and the fully molten polymer is sheared. In the compression section, the void volume between the flights is reduced. In the metering section, the polymer is subjected to its highest shearing amount using low void volume between flights. For this work, general purpose single screw designs were used. In this unit, a continuous or steady state type of process is achieved where the composition components are introduced at desired locations, and then subjected to temperatures and shear within target zones. The process can be considered to be a steady state process as the physical nature of the interaction at each location in the single screw process is constant as a function of time. This allows for optimization of the mixing process by enabling a zone-by-zone adjustment of the temperature and shear, where the shear can be changed through the screw elements and/or barrel design or screw speed.

The mixed composition exiting the single screw extruder can then be pelletized via extrusion of the melt into a liquid cooling medium, often water, and then the polymer strand can be cut into small pieces. There are two basic types of molten polymer pelletization process used in polymer processing: strand cutting and underwater pelletization. In strand cutting the composition is rapidly quenched (generally much less than 10 seconds) in the liquid medium then cut into small pieces. In the underwater pelletization process, the molten polymer is cut into small pieces then simultaneously or immediately thereafter placed in the presence of a low temperature liquid which rapidly quenches and crystallizes the polymer. These methods are commonly known and used within the polymer processing industry.

The polymer strands that come from the extruder are rapidly placed into a water bath, most often having a temperature range of 1° C. to 50° C. (e.g., normally is about room temperature, which is 25° C.). An alternate end use for the mixed composition is further processing into the desired structure, for example fiber spinning or injection molding. The single screw extrusion process can provide for a high level of mixing and high quench rate. A single screw extruder also can be used to further process a pelletized composition into fibers and injection molded articles. For example, the fiber single screw extruder can be a 37 mm system with a standard general purpose screw profile and a 30:1 length to diameter ratio.

For example, the fiber single screw extruder is a 37 mm system with a standard general purpose screw profile and a 30:1 length to diameter ratio. In the single screw extruder case, already produced TPS and thermoplastic polymer can be combined with the oil/wax, or already produced TPS can be combined with oil/wax that is already dispersed within a thermoplastic polymer. In the first case, an already produced TPS formulation can be melted and the oil/wax additive directly injected into the single screw extruder, followed directly by fiber spinning or final end-use product. The mixing in achieved directly within the single screw extruder. In a second case, the oil/wax is added into the TPS in a second step after the base TPS formulation is produced, similar to the procedure for adding it to a thermoplastic polymer, such as, for example, polypropylene.

Twin Screw Extruder:

A twin screw extruder is the typical unit used in most molten polymer extrusion, where high intensity mixing is required. The twin screw extruder includes two shafts and an outer barrel. A typical RPM range for twin screw extruder is about 10 to about 1200. The two shafts can be co-rotating or counter rotating and allow for close tolerance, high intensity mixing. In this type of unit, a continuous or steady state type of process is achieved where the composition components are introduced at desired locations along the screws, and subjected to high temperatures and shear within target zones. The process can be considered to be a steady state process as the physical nature of the interaction at each location in the single screw process is constant as a function of time. This allows for optimization of the mixing process by enabling a zone-by-zone adjustment of the temperature and shear, where the shear can be changed through the screw elements and/or barrel design.

The mixed composition at the end of the twin screw extruder can then be pelletized via extrusion of the melt into a liquid cooling medium, often water, and then the polymer strand is cut into small pieces. There are two basic types of molten polymer pelletization process, strand cutting and underwater pelletization, used in polymer processing. In strand cutting the composition is rapidly quenched (generally much less than 10 s) in the liquid medium then cut into small pieces. In the underwater pelletization process, the molten polymer is cut into small pieces then simultaneously or immediately thereafter placed in the presence of a low temperature liquid which rapidly quenches and crystallizes the polymer. An alternate end use for the mixed composition is further processing into the desired structure, for example fiber spinning or injection molding.

Three different screw profiles can be employed using a Baker Perkins CT-25 25 mm corotating 40:1 length to diameter ratio system. This specific CT-25 is composed of nine zones where the temperature can be controlled, as well as the die temperature. Four liquid injection sites as also possible, located between zone 1 and 2 (location A), zone 2 and 3 (location B), zone 4 and 5 (location C). and zone 6 and 7 (location D).

The liquid injection location is not directly heated, but indirectly through the adjacent zone temperatures. Locations A, B, C and D can be used to inject the additive. Zone 6 can contain a side feeder for adding additional solids or used for venting. Zone 8 contains a vacuum for removing any residual vapor, as needed. Unless noted otherwise, the melted wax is injected at location A. The wax is melted via a glue tank and supplied to the twin-screw via a heated hose Both the glue tank and the supply hose are heated to a temperature greater than the melting point of the wax (e.g., about 80° C.).

Two types of regions, conveyance and mixing, are used in the CT-25. In the conveyance region, the materials are heated (including through melting which is done in Zone 1 into Zone 2 if needed) and conveyed along the length of the barrel, under low to moderate shear. The mixing section contains special elements that dramatically increase shear and mixing. The length and location of the mixing sections can be changed as needed to increase or decrease shear as needed.

Two primary types of mixing elements are used for shearing and mixing. The first are kneading blocks and the second are thermal mechanical energy elements. The simple mixing screw has 10.6% of the total screw length using mixing elements composed of kneading blocks in a single set followed by a reversing element. The kneading elements are RKB 45/5/12 (right handed forward kneading block with 45° offset and five lobes at 12 mm total element length), followed by two RKB 45/5/36 (right handed forward kneading block with 45° offset and five lobes at 36 mm total element length), that is followed by two RKB 45/5/12 and reversing element 24/12 LH (left handed reversing element 24 mm pitch at 12 mm total element length).

The Simple mixing screw mixing elements are located in zone 7. The Intensive screw is composed of additional mixing sections, four in total. The first section is single set of kneading blocks is a single element of RKB45/5/36 (located in zone 2) followed by conveyance elements into zone 3 where the second mixing zone is located. In the second mixing zone, two RKB 45/5/36 elements are directly followed by four TME 22.5/12 (thermomechanical element with 22.5 teeth per revolution and total element length of 12 mm) then two conveyance elements into the third mixing area. The third mixing area, located at the end of zone 4 into zone 5, is composed of three RKB 45/5/36 and a KB45/5/12 LH (left handed forward reversing block with 45° offset and five lobes at 12 mm total element length. The material is conveyed through zone 6 into the final mixing area comprising two TME 22.5/12, seven RKB 45/5/12, followed by SE 24/12 LH. The SE 24/12 LH is a reversing element that enables the last mixing zone to be completely filled with polymer and additive, where the intensive mixing takes place. The reversing elements can control the residence time in a given mixing area and are a key contributor to the level of mixing.

The High Intensity mixing screw is composed of three mixing sections. The first mixing section is located in zone 3 and is two RKB45/5/36 followed by three TME 22.5/12 and then conveyance into the second mixing section. Prior to the second mixing section three RSE 16/16 (right handed conveyance element with 16 mm pitch and 16 mm total element length) elements are used to increase pumping into the second mixing region. The second mixing region, located in zone 5, is composed of three RKB 45/5/36 followed by a KB 45/5/12 LH and then a full reversing element SE 24/12 LH. The combination of the SE 16/16 elements in front of the mixing zone and two reversing elements greatly increases the shear and mixing. The third mixing zone is located in zone 7 and is composed of three RKB 45/5/12, followed by two TME 22.5.12 and then three more RKB45/5/12. The third mixing zone is completed with a reversing element SE 24/12 LH.

An additional screw element type is a reversing element, which can increase the filling level in that part of the screw and provide better mixing. Twin screw compounding is a mature field. One skilled in the art can consult books for proper mixing and dispersion. These types of screw extruders are well understood in the art and a general description can be found in: Twin Screw Extrusion 2E: Technology and Principles by James White from Hansen Publications. Although specific examples are given for mixing, many different combinations are possible using various element configurations to achieve the needed level of mixing.

For in-line production of TPS, 70 wt % solids sorbitol solution can be used to destructure and plasticize the starch to produce TPS. A side feeder can be installed in Zone 6 to vent off the majority of the moisture from the starch and liquid sorbitol. The thermoplastic polymer (e.g., polypropylene or other thermoplastic polymers as described herein) can then added to the destructured starch. The oil/wax can be heated and added into the compounding system at location C or D. In the case where the TPS formulation and the oil/wax are added in the same process, use of a longer L:D ratio extruder is preferred to increase mixing and enable the various process steps to be separated. Extruder ratio above 40:1 are contemplated, preferably up to 60:1 and even longer are considered.

### Properties of Compositions

The compositions as disclosed herein can have one or more of the following properties that provide an advantage over known thermoplastic compositions. These benefits can be present alone or in a combination.

Shear Viscosity Reduction: Viscosity reduction is a process improvement as it can allow for effectively higher polymer flow rates by having a reduced process pressure (lower shear viscosity), or can allow for an increase in polymer and/or TPS molecular weight, which improves the material strength. Without the presence of the oil/wax, it may not be possible to process the polymer and/or TPS with a high polymer flow rate at existing process conditions in a suitable way. Alternatively, the presence of the oil/wax can enable lower process temperatures, which can reduce degradation of the various components (for instance, the TPS component).

Sustainable Content: Inclusion of sustainable materials into the existing polymeric system is a strongly desired property. Materials that can be replaced every year through natural growth cycles contribute to overall lower environmental impact and are desired.

Pigmentation: Adding pigments to polymers often involves using expensive inorganic compounds that are particles within the polymer matrix. These particles are often large and can interfere in the processing of the composition. Using an oil and/or wax as disclosed herein, because of the fine dispersion (as measured by droplet size) and uniform distribution throughout the thermoplastic polymer and/or TPS allows for coloration, such as via traditional ink compounds. Soy ink is widely used in paper publication) that does not impact processability.

Fragrance: Because the oils and/or waxes, for example SBO or HSBO, can contain perfumes much more preferentially than the base thermoplastic polymer and/or TPS, the present composition can be used to contain scents that are beneficial for end-use. Many scented candles are made using SBO based or paraffin based materials, so incorporation of these into the polymer for the final composition is useful.

Morphology: The benefits are delivered via the morphology produced in production of the compositions. The morphology is produced by a combination of intensive mixing and rapid crystallization. The intensive mixing comes from the compounding process used and rapid crystallization comes from the cooling process used. High intensity mixing is desired and rapid crystallization is used to preserves the fine pore size and relatively uniform pore size distribution.

Water Resistance: Adding a hydrophobic material to a TPS material improves water resistance of the starch.

Surface Feel: The presence of the oil/wax can change the surface properties of the composition, often making it feel softer.

### EXAMPLES

Polymers: U.S. Pat. No. 6,783,854 provides a comprehensive list of polymers that are compatible with TPS, although not all have been tested. Current polymeric mixtures have the basic following composition, although it is not limited to the one type described below.

30 wt % TPS: Is a mixture of 70 wt % polypropylene and 30 wt % TPS. The TPS is 70% starch and 30% sorbitol. 10 wt % of the polypropylene is maleated PP, Polybond 3200. The remaining PP can be any number of materials, but those used in the present work is 50 wt % Basell Profax PH-835 and 50 wt % Basell Metocene MF650W.

45 wt % TPS: Is a mixture of 70 wt % polypropylene and 30 wt % TPS. The TPS is 70% starch and 30% sorbitol. 10 wt % of the polypropylene is maleated PP, Polybond 3200. The remaining PP can be any number of materials, but those used in the present work is Basell Moplen HP-562T.

Oils/Waxes: Specific examples used were: Soy Bean Oil (SBO); Hydrogenated Soy Bean Oil (HSBO); Partially Hydrogenated Soy Bean Oil (PHSBO); Epoxidized Soybean Oil (ESBO); Partially Hydrogenated Palm Kernel Oil (PKPKO); candle with pigmentation and fragrance added; and Standard green Soy Bean Green Ink Pigment.

Compositions were made using a Baker Perkins CT-25 Screw twin screw extruder, with the zones set as noted in the below table:

TABLE

| | | | | | | | | | | | | | | | Melt | Oil | | | |
|---|---|---|---|---|---|---|---|---|---|---|---|---|---|---|---|---|---|---|---|
| | | | Ratio | | Twin-Screw Temperature Profile (° C.) | | | | | | | | | | Temp | Temp | Screw | Screw | Torque |
| | Polymer | Oil | Polymer | Oil | Z1 | Z2 | Z3 | Z4 | Z5 | Z6 | Z7 | Z8 | Z9 | Die | (° C.) | (° C.) | RPM | Type | (%) |
| 1 | 30 wt % | SBO | 90 | 10 | 40 | 130 | 170 | 180 | 180 | 180 | 170 | 170 | 140 | 140 | 152 | 80 | 500 | Intensive | 49 |
| | TPS | | | | | | | | | | | | | | | | | | |
| 2 | 30 wt % | SBO | 80 | 20 | 40 | 130 | 170 | 180 | 180 | 180 | 170 | 170 | 140 | 140 | 143 | 80 | 500 | Intensive | 81 |
| | TPS | | | | | | | | | | | | | | | | | | |
| 3 | 30 wt % | SBO | 75 | 25 | 40 | 130 | 170 | 180 | 180 | 180 | 170 | 170 | 140 | 140 | NR | 80 | 500 | Intensive | 37 |
| | TPS | | | | | | | | | | | | | | | | | | |
| 4 | 30 wt % | ESBO | 90 | 10 | 40 | 130 | 170 | 180 | 180 | 180 | 170 | 170 | 140 | 140 | 148 | 80 | 500 | Intensive | 52 |
| | TPS | | | | | | | | | | | | | | | | | | |
| 5 | 30 wt % | ESBO | 85 | 15 | 40 | 130 | 170 | 180 | 180 | 180 | 170 | 170 | 140 | 140 | 153 | 80 | 500 | Intensive | 40 |
| | TPS | | | | | | | | | | | | | | | | | | |
| 6 | 30 wt % | ESBO | 80 | 20 | 40 | 130 | 170 | 180 | 180 | 180 | 170 | 170 | 140 | 140 | 155 | 80 | 500 | Intensive | 36 |
| | TPS | | | | | | | | | | | | | | | | | | |
| 7 | 30 wt % | HSBO | 90 | 10 | 40 | 130 | 170 | 180 | 180 | 180 | 170 | 170 | 140 | 140 | 143 | 80 | 500 | Intensive | 55 |
| | TPS | | | | | | | | | | | | | | | | | | |
| 8 | 30 wt % | HSBO | 85 | 15 | 40 | 130 | 170 | 180 | 180 | 180 | 170 | 170 | 140 | 140 | 150 | 80 | 500 | Intensive | 48 |
| | TPS | | | | | | | | | | | | | | | | | | |
| 9 | 30 wt % | HSBO | 80 | 20 | 40 | 130 | 170 | 180 | 180 | 180 | 170 | 170 | 140 | 140 | 152 | 80 | 500 | Intensive | 43 |
| | TPS | | | | | | | | | | | | | | | | | | |
| 10 | 30 wt % | PHSBO | 90 | 10 | 40 | 130 | 170 | 180 | 180 | 180 | 170 | 170 | 140 | 140 | 144 | 80 | 500 | Intensive | 57 |
| | TPS | | | | | | | | | | | | | | | | | | |
| 11 | 30 wt % | PHSBO | 85 | 15 | 40 | 130 | 170 | 180 | 180 | 180 | 170 | 170 | 140 | 140 | 142 | 80 | 500 | Intensive | 49 |
| | TPS | | | | | | | | | | | | | | | | | | |
| 12 | 30 wt % | PHSBO | 80 | 20 | 40 | 130 | 170 | 180 | 180 | 180 | 170 | 170 | 140 | 140 | 145 | 80 | 500 | Intensive | 44 |
| | TPS | | | | | | | | | | | | | | | | | | |
| 13 | 30 wt % | HSBO | 95 | 5 | 40 | 130 | 170 | 180 | 180 | 180 | 170 | 170 | 140 | 140 | 178 | 80 | 500 | High | 71 |
| | TPS | | | | | | | | | | | | | | | | | | |
| 14 | 30 wt % | HSBO | 90 | 10 | 40 | 130 | 170 | 180 | 180 | 180 | 170 | 170 | 140 | 140 | 167 | 80 | 500 | High | 69 |
| | TPS | | | | | | | | | | | | | | | | | | |
| 15 | 30 wt % | HSBO | 85 | 15 | 40 | 130 | 170 | 180 | 180 | 180 | 170 | 170 | 140 | 140 | 170 | 80 | 500 | High | 55 |
| | TPS | | | | | | | | | | | | | | | | | | |
| 16 | 30 wt % | HSBO | 80 | 20 | 40 | 130 | 170 | 180 | 180 | 180 | 170 | 170 | 140 | 140 | 175 | 80 | 500 | High | 48 |
| | TPS | | | | | | | | | | | | | | | | | | |
| 17 | 30 wt % | HSBO | 80 | 20 | 40 | 130 | 170 | 180 | 180 | 180 | 170 | 170 | 140 | 140 | 174 | 80 | 500 | High | 43 |
| | TPS | | | | | | | | | | | | | | | | | | |
| 18 | 30 wt % | HSBO | 75 | 25 | 40 | 130 | 170 | 180 | 180 | 180 | 170 | 170 | 140 | 140 | 175 | 80 | 500 | High | 34 |
| | TPS | | | | | | | | | | | | | | | | | | |
| 19 | 30 wt % | HSBO | 70 | 30 | 40 | 130 | 170 | 180 | 180 | 180 | 170 | 170 | 140 | 140 | 175 | 80 | 500 | High | 34 |
| | TPS | | | | | | | | | | | | | | | | | | |
| 20 | 30 wt % | HSBO | 65 | 35 | 40 | 130 | 170 | 180 | 180 | 180 | 170 | 170 | 140 | 140 | 172 | 80 | 500 | High | 29 |
| | TPS | | | | | | | | | | | | | | | | | | |
| 21 | 30 wt % | SBO | 95 | 5 | 40 | 130 | 170 | 180 | 180 | 180 | 170 | 170 | 140 | 140 | 172 | 80 | 400 | High | 62 |
| | TPS | | | | | | | | | | | | | | | | | | |
| 22 | 30 wt % | SBO | 90 | 10 | 40 | 130 | 170 | 180 | 180 | 180 | 170 | 170 | 140 | 140 | 172 | 80 | 400 | High | 58 |
| | TPS | | | | | | | | | | | | | | | | | | |
| 23 | 30 wt % | SBO | 85 | 15 | 40 | 130 | 170 | 180 | 180 | 180 | 170 | 170 | 140 | 140 | 174 | 80 | 400 | High | 52 |
| | TPS | | | | | | | | | | | | | | | | | | |
| 24 | 30 wt % | SBO | 80 | 20 | 40 | 130 | 170 | 180 | 180 | 180 | 170 | 170 | 140 | 140 | 175 | 80 | 400 | High | 45 |
| | TPS | | | | | | | | | | | | | | | | | | |
| 25 | 30 wt % | SBO | 75 | 25 | 40 | 130 | 170 | 180 | 180 | 180 | 170 | 170 | 140 | 140 | 175 | 80 | 400 | High | 37 |
| | TPS | | | | | | | | | | | | | | | | | | |
| 26 | 30 wt % | SBO | 70 | 30 | 40 | 130 | 170 | 180 | 180 | 180 | 170 | 170 | 140 | 140 | NR | 80 | 400 | High | NR |
| | TPS | | | | | | | | | | | | | | | | | | |
| 27 | 30 wt % | HSBO | 70 | 30 | 40 | 130 | 170 | 180 | 180 | 180 | 170 | 170 | 140 | 140 | 175 | 80 | 400 | High | 34 |
| | TPS | | | | | | | | | | | | | | | | | | |
| 28 | 45 wt % | HSBO | 90 | 10 | 40 | 130 | 170 | 180 | 180 | 180 | 170 | 170 | 140 | 140 | 170 | 80 | 400 | High | 43 |
| | TPS | | | | | | | | | | | | | | | | | | |
| 29 | 45 wt % | HSBO | 85 | 15 | 40 | 130 | 170 | 180 | 180 | 180 | 170 | 170 | 140 | 140 | NR | 80 | 400 | High | NR |
| | TPS | | | | | | | | | | | | | | | | | | |

For examples 3, 6, and 26, it was noted that the oil was surging at the end of the CT-25 extruder. Examples 3 and 6 failed to properly pelletize. For examples 17-20, 25, and 27, vacuum eliminated blooming at strand outlet of the extruder.

Examples 1-29 demonstrate that one can add oils and waxes to TPS. In Examples 1-29, the TPS resin has been pre-compounded to destructure the starch. Although not required, the oil and wax in Examples 1-29 were added in a second compounding step. What was observed was that with a stable composition (e.g., able to be extruded and/or pelletized), strands from the B&P 25 mm system could be extruded, quenched in a water bath at 5° C. and cut via a pelletizer without interruption. The twin-screw extrudiate was immediately dropped into the water bath.

During stable extrusion, no significant amount of oil/wax separated from the formulation strand (>99 wt % made it through the pelletizer). Saturation of the composition can be noted by separation of the polymer and oil/wax from each other at the end of the twin-screw. The saturation point of the oil/wax in the composition can change based on the oil/wax and polymer combination, along with the process conditions. The practical utility is that the oil/wax and polymer remain admixed and do not separate, which is a function of the mixing level and quench rate for proper dispersion of the additive. Specific Examples where the extrusion became unstable from high oil/wax inclusion are Example 3 and 6.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising an intimate admixture of
(a) a thermoplastic starch;
(b) a thermoplastic polymer; and
(c) an oil, wax, or combination thereof present in an amount of about 5 wt % to about 40 wt %, based upon the total weight of the composition.

2. The composition of claim 1, wherein the thermoplastic polymer comprises a polyolefin, a polyester, a polyamide, copolymers thereof, or combinations thereof.

3. The composition of claim 2, wherein the thermoplastic polymer is selected from the group consisting of polypropylene, polyethylene, polypropylene co-polymer, polyethylene co-polymer, polyethylene terephthalate, polybutylene terepthalate, polylactic acid, polyhydroxyalkanoates, polyamide-6, polyamide-6,6, and combinations thereof.

4. The composition of claim 1, wherein the thermoplastic polymer comprises polypropylene.

5. The composition of claim 4, wherein the polypropylene has a molecular weight of about 20 kDa to about 400 kDa.

6. The composition of claim 4, wherein the polypropylene has a melt flow index of greater than 5 g/10 min.

7. The composition of claim 6, wherein the polypropylene has a melt flow index of greater than 10 g/10 min.

8. The composition of claim 1, comprising about 20 wt % to about 90 wt % of the thermoplastic polymer, based upon the total weight of the composition.

9. The composition of claim 8, comprising about 30 wt % to 70 wt % of the thermoplastic polymer, based upon the total weight of the composition.

10. The composition of claim 1, comprising about 8 wt % to about 30 wt % of the oil, wax, or combination thereof, based upon the total weight of the composition.

11. The composition of claim 10, comprising about 10 wt % to about 20 wt % of the oil, wax or combination thereof, based upon the total weight of the composition.

12. The composition of claim 1, wherein the oil, wax or combination thereof comprises a lipid.

13. The composition of claim 12, wherein the lipid comprises a monoglyceride, diglyceride, triglyceride, fatty acid, fatty alcohol, esterified fatty acid, epoxidized lipid, maleated lipid, hydrogenated lipid, alkyd resin derived from a lipid, sucrose polyester, or combinations thereof.

14. The composition of claim 1, wherein the oil, wax, or combination thereof comprises a mineral oil or mineral wax.

15. The composition of claim 14, wherein the mineral oil or mineral wax comprises a linear alkane, a branched alkane, or combinations thereof.

16. The composition of claim 1, wherein the oil, wax, or combination thereof is selected from the group consisting of soy bean oil, epoxidized soy bean oil, maleated soy bean oil, corn oil, cottonseed oil, canola oil, beef tallow, castor oil, coconut oil, coconut seed oil, corn germ oil, fish oil, linseed oil, olive oil, oiticica oil, palm kernel oil, palm oil, palm seed oil, peanut oil, rapeseed oil, safflower oil, sperm oil, sunflower seed oil, tall oil, tung oil, whale oil, tristearin, triolein, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, trilinolein, 1,2-dipalmitolinolein, 1-palmito-dilinolein, 1-stearo-dilinolein, 1,2-diacetopalmitin, 1,2-distearo-olein, 1,3-distearo-olein, trimyristin, trilaurin, capric acid, caproic acid, caprylic acid, lauric acid, lauroleic acid, linoleic acid, linolenic acid, myristic acid, myristoleic acid, oleic acid, palmitic acid, palmitoleic acid, stearic acid, and combinations thereof.

17. The composition of claim 1, wherein the wax is selected from the group consisting of a hydrogenated plant oil, a partially hydrogenated plant oil, an epoxidized plant oil, a maleated plant oil, and combinations thereof.

18. The composition of claim 17, wherein the plant oil is soy bean oil, corn oil, canola oil, palm kernel oil, or a combination thereof.

19. The composition of claim 1, wherein the oil, wax, or combination thereof is dispersed within the thermoplastic polymer such that the oil, wax, or combination thereof has a droplet size of less than 10 μm within the thermoplastic polymer.

20. The composition of claim 19, wherein the droplet size is less than 5 μm.

21. The composition of claim 20, wherein the droplet size is less than 1 μm.

22. The composition of claim 1, further comprising a nucleating agent.

23. The composition of claim 1, wherein the thermoplastic starch comprises starch or a starch derivative and a plasticizer.

24. The composition of claim 23, wherein the plasticizer comprises a polyol.

25. The composition of claim 24, wherein the polyol is selected from the group consisting of mannitol, sorbitol, glycerin, and combinations thereof.

26. The composition of claim 23, wherein the plasticizer is selected from the group consisting of glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2,6-hexanetriol, 1,3,5-hexanetriol, neopentyl glycol, trimethylolpropane, pentaerythritol, sorbitol, glycerol ethoxylate, tridecyl adipate, isodecyl benzoate, tributyl citrate, tributyl phosphate, dimethyl sebacate, urea, pentaerythritol ethoxylate, sorbitol acetate, pentaerythritol acetate, ethylenebisformamide, sorbitol diacetate, sorbitol monoethoxylate, sorbitol diethoxylate, sorbitol hexaethoxylate, sorbitol dipropoxylate, aminosorbitol, trihydroxymethylaminomethane, glucose/PEG, a reaction product of ethylene oxide with glucose, trimethylolpropane monoethoxylate, mannitol monoacetate, mannitol monoethoxylate, butyl glucoside, glucose monoethoxylate, α-methyl glucoside, carboxymethylsorbitol sodium salt, sodium lactate, polyglycerol monoethoxylate, erythriol, arabitol, adonitol, xylitol, mannitol, iditol, galactitol, allitol, malitol, formaide, N-methylformamide, dimethyl sulfoxide, an alkylamide, a polyglycerol having 2 to 10 repeating units, and combinations thereof.

27. The composition of claim 23, wherein the starch or starch derivative is selected from the group consisting of starch, hydroxyethyl starch, hydroxypropyl starch, carboxymethylated starch, starch phosphate, starch acetate, a cationic starch, (2-hydroxy-3-trimethyl(ammoniumpropyl) starch chloride, a starch modified by acid, base, or enzyme hydrolysis, a starch modified by oxidation, and combinations thereof.

28. The composition of claim 23, comprising about 10 wt % to about 80 wt % of the thermoplastic starch, based upon the total weight of the composition.

29. The composition of claim 28, comprising about 20 wt % to about 40 wt % of the thermoplastic starch, based upon the total weight percent of the composition.

30. The composition of claim 1, further comprising an additive.

31. The composition of claim 30, wherein the additive is oil soluble or oil dispersible.

32. The composition of claim 30, wherein the additive is a perfume, dye, pigment, surfactant, nanoparticle, antistatic agent, filler, or combination thereof.

33. The composition of claim 1, wherein the oil, wax, or combination thereof is a renewable material.

34. A method of making the composition of claim 1, comprising
a) mixing the thermoplastic polymer, in a molten state, the thermoplastic starch, in a molten state, and the oil, wax, or combination thereof to form the admixture; and
b) cooling the admixture to form the composition.

35. A method comprising
a) melting a thermoplastic polymer to form a molten thermoplastic starch;
b) melting a thermoplastic starch to form a molten thermoplastic polymer;
c) mixing the molten thermoplastic starch and the molten thermoplastic polymer with an oil, wax, or combination thereof to form an admixture; and
d) cooling the admixture to 50° C. or less in 10 seconds or less.

36. The method of claim 34, comprising mixing the admixture with a shear at a rate greater than 10 s⁻¹.

37. The method of claim 36, wherein the shear rate is about 30 to about 100 s⁻¹.

38. The method of any one of claim 34, comprising mixing the admixture using an extruder.

39. The method of claim 38, wherein the extruder is a single screw extruder.

40. The method of claim 38, wherein the extruder is a twin screw extruder.

41. The method of claim 34, comprising cooling the admixture in 10 seconds or less to a temperature of 50° C. or less.

42. The method of claim 34, further comprising pelletizing the admixture.

43. The method of claim 42, wherein pelletizing is after cooling the admixture.

44. The method of claim 42, wherein pelletizing is before or simultaneous to cooling the admixture.

45. A composition prepared by a method comprising
a) melting a thermoplastic polymer to form a molten thermoplastic starch;
b) melting a thermoplastic starch to form a molten thermoplastic polymer;
c) mixing the molten thermoplastic starch and the molten thermoplastic polymer with an oil, wax, or combination thereof to form an admixture; and
d) cooling the admixture to 50° C. or less in 10 seconds or less to form the composition.
